(19) United States
(12) Patent Application Publication
(10) Pub. No.: US 2017/0334333 A1
(43) Pub. Date: Nov. 23, 2017

(54) EDDIE SYSTEM

(71) Applicant: Steven Miccio, Trenton, NJ (US)

(72) Inventor: Steven Miccio, Trenton, NJ (US)

(21) Appl. No.: 15/589,737

(22) Filed: May 8, 2017

Related U.S. Application Data
(60) Provisional application No. 62/339,291, filed on May 20, 2016.
(60) Provisional application No. 62/452,903, filed on Jan. 31, 2017.

(51) Int. Cl. B60P 7/08

(52) U.S. Cl. CPC B60P 7/0807

(57) ABSTRACT

A composite structure for use in cargo control and an article of manufacture are disclosed. The various embodiments enable, support and/or provide a new paradigm in cargo control. These embodiments disclose a device that can be used as an anchor thereby replacing the traditional ratchet, stud tie downs and the like. However, no holes are required to attach the device in place. In addition, the device can be constructed using a variety of materials. The composite structure can also be configured for use with a ladder rack thereby minimizing or even eliminating rail damage.

### CROSS REFERENCE TO RELATED APPLICATIONS

This application claims the benefit to U.S. Provisional Application No. 62/339,291, filed on May 20, 2016 and 62/452,903 filed on Jan. 31, 2017, which applications are incorporated herein by reference as if set forth in its entireties.

### FIELD OF THE INVENTION

The invention relates generally to cargo control; and more specifically, to an anchor tie down.

### BACKGROUND

It has long been the practice to use anchor tie down, strap tie down and the like for cargo control. These devices take relatively long time to put in place and are not flexible.

### SUMMARY

Various deficiencies of the prior art are addressed by a composite structure for use in cargo control and an article of manufacture. One embodiment comprises a composite structure for use in cargo control, which comprises a body at the distal end of the composite structure comprising a tongue at one end and opposite said tongue is material in a ring shape defining a hole there through, said body attached to a stud; the stud having a primary surface area attached to a mounting apparatus forming a first arrangement; and a nut attached to the first arrangement at the proximal end of the composite structure to thereby form an Eddie system; wherein no apertures are required to attach the Eddie system in place.

Another embodiment comprises an article of manufacture, which includes a composite structure configured for use as an Eddie system, wherein the composite structure comprises a tongue at one end and opposite said tongue is material in a ring shape defining a hole there through, said body attached to a stud; the stud having a primary surface area attached to a mounting apparatus forming a first arrangement; and a nut attached to the first arrangement at the proximal end of the composite structure to thereby form an Eddie system; wherein no apertures are required to attach the Eddie system in place.

### BRIEF DESCRIPTION OF THE DRAWINGS

The teachings of the present invention can be readily understood by considering the following detailed description in conjunction with the accompanying drawings, which:

FIG. 1 depicts an exemplary Eddie System according to an embodiment;

FIG. 2 depicts illustrative views of the body and stud of the Eddie System according to an embodiment; and

FIG. 3 depicts illustrative views of the mounting apparatus and nut of the Eddie System according to an embodiment.

To facilitate understanding, identical reference numerals have been used, where possible, to designate elements having substantially the same or similar structure and/or substantially the same or similar function.

### DETAILED DESCRIPTION

The invention will be primarily described within the context of particular embodiments; however, those skilled in the art and informed by the teachings herein will realize that the invention is also applicable to other technical areas and/or embodiments.

The illustrative embodiments described herein are not meant to be limiting. It may be readily understood that certain aspects of the disclosed embodiments can be arranged and combined in a variety of different configurations, all of which are contemplated herein.

Generally speaking, the various embodiments enable, support and/or provide a new paradigm in cargo control. These embodiments disclose a device that can be used as an anchor thereby replacing the traditional ratchet, stud tie downs and the like. However, no holes are required to attach the device in place. In addition, the device can be constructed using a variety of materials. For example, in one embodiment the device is made using plastic with metal core for strength. In another embodiment, aluminum can be used for more cost effectiveness (cost factor). A protective coating can be added or the device can be anodized. In other embodiments, the use of any device having similar functionality is considered to be within the scope of the present embodiments.

Various embodiments operate to provide a composite structure having a body, a stud, a mounting arrangement and a nut. In one embodiment, composite structure 100 is configured for use with a pick-up truck. In other embodiments, composite structure 100 is configured for use with a ladder rack thereby minimizing or even eliminating rail damage. In yet other embodiments, composite structure 100 is configured with wider or more gap for use with devices with thicker mounting flanges such as truck caps and the like.

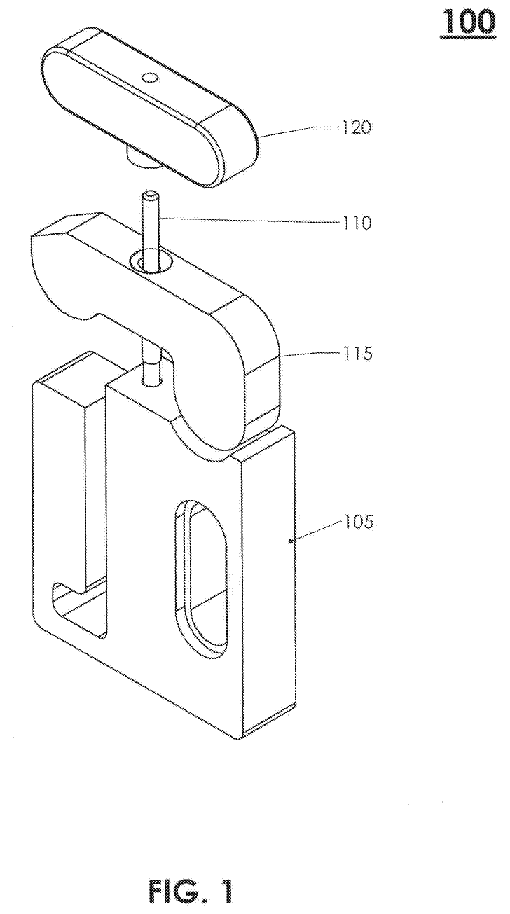

FIG. 1 depicts an exemplary Eddie System according to an embodiment. Specifically, FIG. 1 depicts a composite structure 100 that includes a body 105, a stud 110, a dog bone shaped mounting apparatus 115, which is shaped as dog bone and a nut 120. Body 105 is attached to stud 110 at the distal end of composite structure 100. Stud 110 in turn is attached to mounting structure 115 thereby forming a first arrangement, which is attached to a nut at the proximal end of composite structure to thereby form an Eddie System.

As described above, one embodiment of the Eddie system provides an arrangement for use with a pick-up truck. For such use, dog bone shaped mounting apparatus 115 is rotated perpendicular to body 105, which is raised under the rail of the bed of the truck. Dog bone shaped mounting apparatus 115 is then rotated parallel to body 105, which is then pulled against the truck bed rail. Nut 120 is then tightened. The Eddie system is then ready for use. A rope or ratchet strap may be inserted or hooked to the tie down hole. The Eddie system is removed by performing the reverse actions. Specifically, the nut is loosened. Dog bone shaped mounting apparatus 115 is rotated perpendicular to body 105, which is pushed away from the rail of the truck's bed. Next, the Eddie system is lowered from the rail in the opposite direction. The Eddie system is now removed.

In another embodiment, composite structure 100 is configured for use with a ladder rack thereby minimizing or even eliminating rail damage. The mounting and removal procedure for the Eddie system is the same as articulated above.

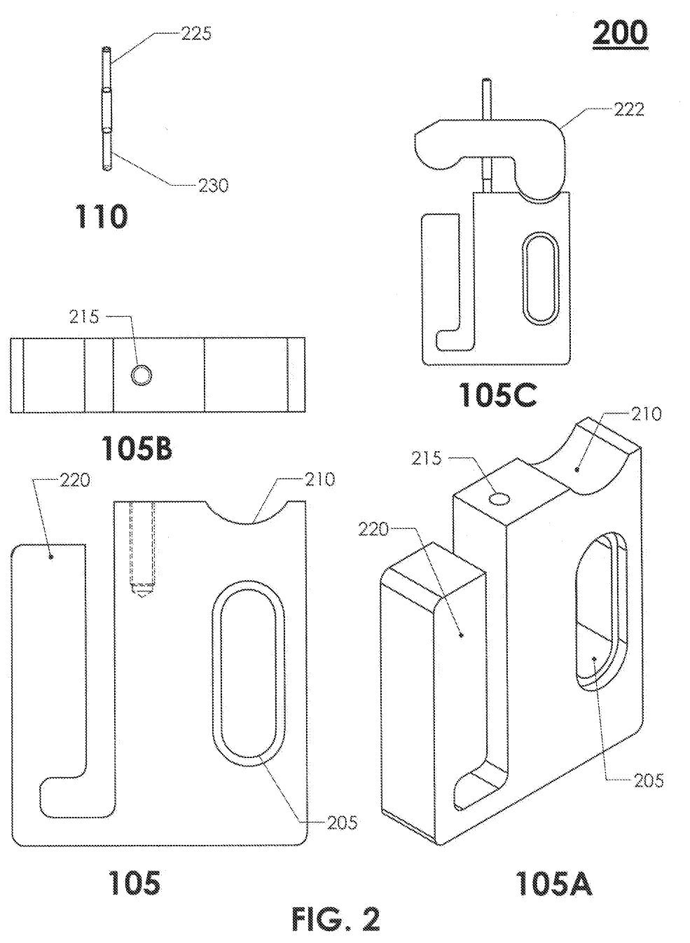

FIG. 2 depicts illustrative views of the body and stud of the Eddie System according to an embodiment. As shown, body 105 comprises tie down hole 205, radius for dog bone fulcrum 210, thread 215 for stud 110 and body extension 220.

In one embodiment, offset tie down hole 205 is oval. In other embodiments, tie down hole 205 is rectangle. In yet other embodiments, tie down hole 205 is square. Although depicted and described with respect to an embodiment in which tie down hole 205 assumes common shapes, it will be appreciated by those skilled in the art that tie down hole 205 may be implemented differently without departing from the objective of the invention. Body 105 further comprises radius 210 configured to mate with dog bone shaped mounting apparatus 115 fulcrum. Additionally, body 105 incorporates tong or body extension 220 and thread 215, which accommodates stud 110. Specifically, stud 110 mates with body 105 via thread 230 and nut 120 via thread 225.

In one embodiment, dog bone 115 in conjunction with body extension or tong 220 becomes offset dog bone 222. The length of body extension 220 is adjustable. As such, offset dog bone 222 allows for more gap for devices with thicker mounting flanges. In one embodiment, the device is a truck cap. In other embodiments, devices with similar or different dimension requirements are accommodated. Dog bone fulcrum 210 is adjusted accordingly.

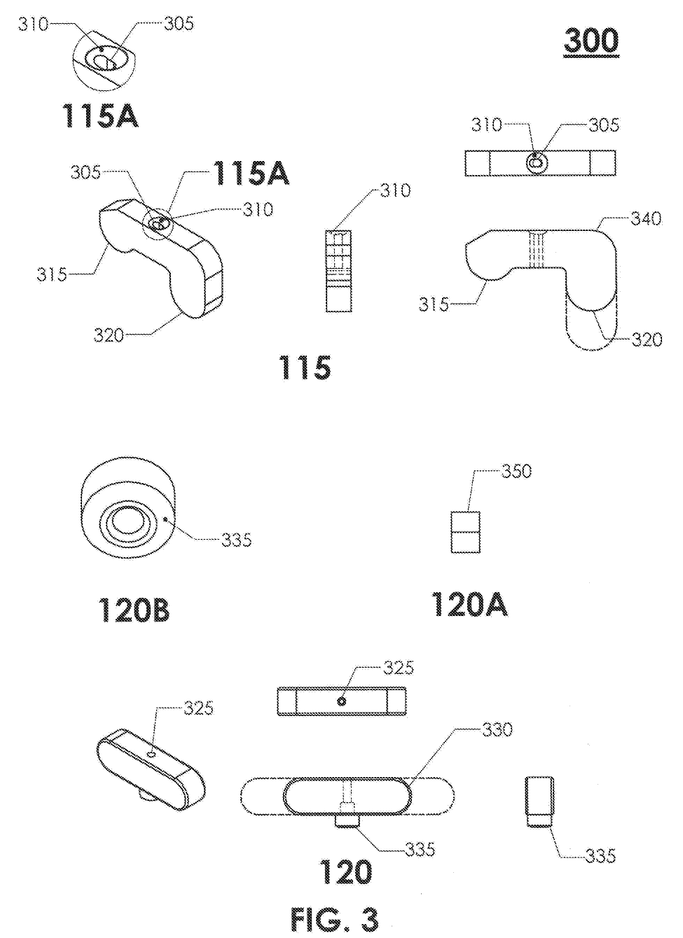

FIG. 3 depicts illustrative views of the mounting apparatus of the Eddie System according to an embodiment. The main components or elements of the Eddie System namely, body 105, stud 110, dog bone shaped mounting apparatus 115 and nut 120 are each multifunctional element.

As shown in FIG. 3, dog bone 115 comprises slot 305, clamping radius 315 and fulcrum radius or lobe 320. Slot 305 allows dog bone 115 to pivot over stud 110. Slot 305 comprises concave surface 310 on one end to mate with nut 120 and convex surface area 335 to mate with dog bone concave surface. Clamping radius 315 allows contact with payload rail in any pivot position dog bone shaped mounting structure 115 is in. In one embodiment, the payload is a truck bed. In another embodiment, the payload is a ladder rack. Moreover, dog bone shaped mounting structure 115 comprises fulcrum radius or lobe 320 to mate with body radius 210. When lobe 320 is extended as shown, dog bone shaped mounting structure 115 is configured in the offset mode as explained above. The offset length is measured from 340 to the end of the lobe.

As shown in FIG. 3, nut 120 incorporates thread 325, which mates with stud 110 and incorporates convex surface 335 to mate with dog bone concave surface. Furthermore, nut 120 comprises handle 330, which is of variable length for better torque. In one embodiment, nut 120 comprises a “TEE” nut whereas in another embodiment nut 120 comprises a straight nut. In this embodiment, nut 120 comprises a hex or square head 350.

The Eddie System is used in various ways. For example, by way of illustration one way to use the system is to rotate dog bone 115 perpendicular to body 105, which is raised under the rail of the bed of a truck or another apparatus. Dog bone 115 is then rotated parallel to body 105, which is then pulled against the truck bed rail. Nut 120 is then tightened. The Eddie System is now ready for use. A rope or ratchet strap may be inserted or hooked to tie down hole 205. To remove the Eddie System or composite structure 100, loosen nut 120, rotate dog bone 115 perpendicular to body 105. Push body 105 away from the truck bed rail in the opposite direction. Nest lower the Eddie System from the rail in the opposite direction. The Eddie System is now removed.

Another way to use the Eddie System is to place a truck cap on the truck bed. The dog bone is rotated perpendicular to body 105, which is raised under the rail of the bed of the truck. Dog bone 115 is then rotated parallel to body 105, which is then pulled against the truck bed rail. Nut 120 is tightened. As a result, dog bone 115 is now clamping in the truck bed rail. To remove the Eddie System or composite structure 100, loosen nut 120, rotate dog bone 115 perpendicular to body 105. Push body 105 away from the truck bed rail in the opposite direction. Nest lower the Eddie System from the rail in the opposite direction. The Eddie System is now removed allowing the truck cap to be removed.

Although various embodiments, which incorporate the teachings of the present invention have been shown and described in detail herein, those skilled in the art can readily devise many other varied embodiments that still incorporate these teachings. For example, a combination of stamping process and high-speed manufacturing can be used to produce composite structure 100. The shape of certain parts of composite structure 100 can be varied and/or changed to accomplish the same functionality.

It is contemplated that some of the steps discussed herein as manufacturing methods may be implemented manually.

We claim:

1. A composite structure for use in cargo control, comprising:
a body at the distal end of the composite structure comprising a tongue at one end and opposite said tongue is material in a ring shape defining a hole therethrough, said body attached to a stud;
the stud having a primary surface area attached to a mounting apparatus forming a first arrangement; and
a nut attached to the first arrangement at the proximal end of the composite structure to thereby form an Eddie system;
wherein no apertures are required to attach the Eddie system in place.

2. The composite structure of claim 1, wherein the body includes a radius to mate with the mounting apparatus fulcrum.

3. The composite structure of claim 1, wherein the hole is an oval shaped tie down hole.

4. The composite structure of claim 1, wherein the body is threaded to mate with the stud.

5. The composite structure of claim 1, wherein the tongue is off-set from the mounting apparatus.

6. The composite structure of claim 1, wherein the concave area of the mounting apparatus is configured to mate with the convex area of the nut.

7. The composite structure of claim 1, wherein the geometry of the mounting apparatus is shaped as a dog bone.

8. The composite structure of claim 1, wherein the dog bone when extended comprises a lobe configured to operate in the offset mode.

9. The composite structure of claim 1, wherein the geometry of the mounting apparatus includes a fulcrum radius to mate with the radius of the body.

10. The composite structure of claim 6, wherein the geometry of the mounting apparatus includes a clamping radius.

11. The composite structure of claim 1, wherein the nut is a tee nut.

12. The composite structure of claim 1, wherein the nut is a hex nut.

13. A composite structure for use in cargo control, comprising:
means for attaching a body at the distal end of the composite structure to a stud;
means for the stud having a convex primary surface area to be attached to a mounting apparatus forming a first arrangement;
means for attaching a nut to the first arrangement at the proximal end of the composite structure to thereby form an Eddie system.

14. An article of manufacture, comprising:
a composite structure configured for use as an Eddie system, wherein the composite structure comprises a tongue at one end and opposite said tongue is material in a ring shape defining a hole therethrough, said body attached to a stud;
the stud having a primary surface area attached to a mounting apparatus forming a first arrangement; and
a nut attached to the first arrangement at the proximal end of the composite structure to thereby form an Eddie system;
wherein no apertures are required to attach the Eddie system in place.
